(19) United States
(12) Patent Application Publication
(10) Pub. No.: US 2025/0086112 A1
(43) Pub. Date: Mar. 13, 2025

(54) MEMORY CONTROL SYSTEM AND MEMORY CONTROL METHOD FOR REDUCING MEMORY TRAFFIC

(71) Applicant: MEDIATEK INC., Hsinchu City (TW)

(72) Inventors: Hsing-Chuang Liu, Hsinchu City (TW); Cheng-Chih Hsiao, Hsinchu City (TW); Hsien-Hua Hsieh, Hsinchu City (TW)

(73) Assignee: MEDIATEK INC., Hsinchu City (TW)

(21) Appl. No.: 18/827,870

(22) Filed: Sep. 9, 2024

Related U.S. Application Data
(60) Provisional application No. 63/537,210, filed on Sep. 8, 2023.

(51) Int. Cl. G06F 12/0802

(52) U.S. Cl. CPC G06F 12/0802

(57) ABSTRACT

A memory control method includes a processor initiating a memory access instruction to a cache controller to search a cache memory, an address detector checking if the memory access instruction is corresponding to predetermined conditions if a cache miss occurs, the address detector transmitting a signal to inform a replacement mask logic unit if the memory access instruction is corresponding to the predetermined conditions, and the replacement mask logic unit providing predetermined data to store the predetermined data into the cache memory.

### CROSS REFERENCE TO RELATED APPLICATIONS

This application claims the benefit of U.S. Provisional Application No. 63/537,210, filed on Sep. 8, 2023. The content of the application is incorporated herein by reference.

### BACKGROUND

As systems, integrated chips and system-on-chip (SoC) designs grow increasingly intricate, the demand for memory access intensifies, while memory latencies continue to lengthen. Managing these memories effectively poses a significant challenge. Presently, strategies such as augmenting cache memory sizes and enhancing data pre-fetching from main memory to cache are employed to mitigate memory latencies. However, these approaches come at the cost of increased expenses and heightened memory traffic. Consequently, there remains a need for innovative solutions in this domain to enhance memory management.

### SUMMARY

An embodiment provides a memory control method after a cache controller processing a memory access instruction to search a cache memory and a cache miss occurs. The memory control method comprises checking, by an address detector, if the memory access instruction corresponds to predetermined conditions; transmitting, by the address detector, a signal to inform a replacement mask logic unit while the memory access instruction corresponds to the predetermined conditions; and providing, by the replacement mask logic unit, predetermined data to store the predetermined data into the cache memory.

Another embodiment provides a memory control system. The memory control system includes a processor, a cache memory, a cache controller, a bus transaction controller, an address detector and a replacement mask logic unit. The processor is used to initiate a memory access instruction. The cache controller is coupled to the processor and the cache memory and used to receive the memory access instruction to search the cache memory and transmit a first signal if the a cache miss occurs. The bus transaction controller is coupled to the cache controller and used to receive the first signal, and transmit a second signal corresponding to the first signal. The address detector is coupled to the bus transaction controller and used to receive the second signal, check if the memory access instruction is corresponding to predetermined conditions, and transmit a third signal if the memory access instruction is corresponding to the predetermined conditions. The replacement mask logic unit is coupled to the address detector and the bus transaction controller and configured to receive the third signal and provide predetermined data to the bus transaction controller to store the predetermined data into the cache memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a memory control system according to an embodiment.

FIG. 2 is a flow chart of a memory control method according to an embodiment.

### DETAILED DESCRIPTION

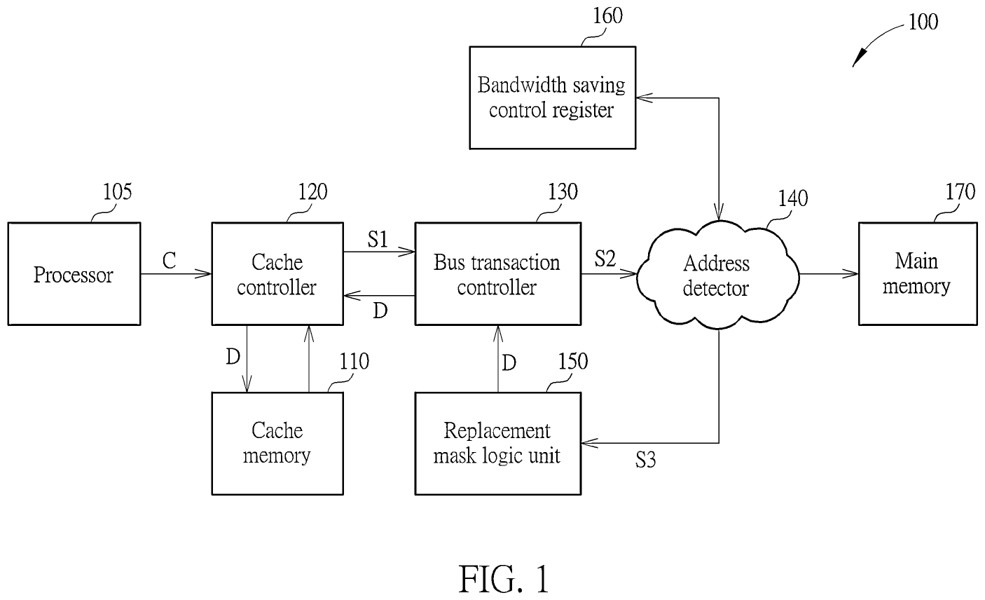

FIG. 1 illustrates a memory control system 100 according to an embodiment. The memory control system 100 can include a processor 105, a cache memory 110, a cache controller 120, a bus transaction controller 130, an address detector 140, a replacement mask logic unit 150, a bandwidth saving control register 160 and a main memory 170. The memory control system 100 can be used to reduce the number of accesses to the main memory 170.

The processor 105 can initiate a memory access instruction C. The cache controller 120 can be coupled to the processor 105 and the cache memory 110 for receiving the memory access instruction C to search the cache memory 110. The cache controller 120 can transmit a first signal S1 if a cache miss occurs. Here, a cache miss may mean an event in which a processor or application makes a request to retrieve data from a cache memory, but that data is not in the cache memory.

The bus transaction controller 130 can be coupled to the cache controller 120 for receiving the first signal S1, and transmitting a second signal S2 corresponding to the first signal S1. The address detector 140 can be coupled to the bus transaction controller 130 for receiving the second signal S2. After receiving the second signal S2, the address detector 140 can check if the memory access instruction C is corresponding to predetermined conditions. The address detector 140 can transmit a third signal S3 to inform the replacement mask logic unit 150 if the memory access instruction C is corresponding to the predetermined conditions. The predetermined conditions will be described below.

The replacement mask logic unit 150 can be coupled to the address detector 140 and the bus transaction controller 130. The replacement mask logic unit 150 can receive the third signal S3 and provide predetermined data D to the bus transaction controller 130 to store the predetermined data D into the cache memory 110. For example, the predetermined data D can be null data.

As shown in FIG. 1, the memory control system 100 can further include a bandwidth saving control register 160 coupled to the address detector 140. For example, the address detector 140 can check if the memory access instruction C is corresponding to the predetermined conditions by checking if the bandwidth saving control register 160 is set to have a predetermined value. Regarding the predetermined conditions, more details are described below.

The processor 105 may include a central processing unit (CPU), a graphic processing unit (GPU), a tensor processing unit (TPU), a neural network processing unit (NPU), an application specific integrated circuit (ASIC), a deep learning processing unit (DPU), a vector processing unit (VPU), a microprocessor, a micro controller unit (MCU) and/or an appropriate processing unit.

The cache memory 110 can be a static random-access memory (SRAM). The main memory 170 can be a dynamic random-access memory (DRAM).

The bus transaction controller 130, the address detector 140, the replacement mask logic unit 150 and the bandwidth saving control register 160 can be separated or integrated in a device. The bus transaction controller 130, the address detector 140, the replacement mask logic unit 150 and the bandwidth saving control register 160 can be implemented using proper hardware, software and/or firmware. The bus transaction controller 130, the address detector 140, the replacement mask logic unit 150 and the bandwidth saving control register 160 can be implemented in an integrated circuit such as an application specific integrated circuit (ASIC). Each of the bus transaction controller 130, the address detector 140, the replacement mask logic unit 150 and the bandwidth saving control register 160 can be implemented with a software block. The cache memory 110 can include a valid bit, a dirty bit, a tag bit and/or a data bit to manage the data in the cache memory 110. Among the processor 105, the cache memory 110, the cache controller 120, the bus transaction controller 130, the address detector 140, the replacement mask logic unit 150, the bandwidth saving control register 160 and the main memory 170, physical paths and/or wireless paths can be used for connections. If needed, proper interfaces can be used for connections.

According to embodiments, a memory control method after a cache controller processing a memory access instruction to search a cache memory and a cache miss occurs can be provided. The memory control method can include:
checking, by the address detector, if the memory access instruction corresponds to predetermined conditions;
transmitting, by the address detector, a signal to inform a replacement mask logic unit while the memory access instruction corresponds to the predetermined conditions; and
providing, by the replacement mask logic unit, predetermined data to store the predetermined data into the cache memory.

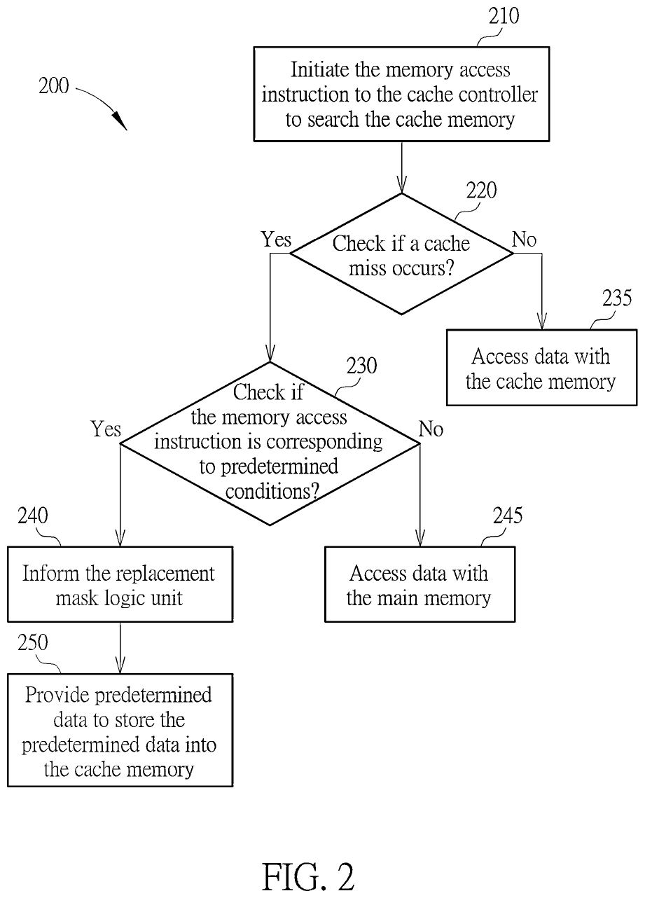

FIG. 2 is a flow chart of a memory control method 200 according to an embodiment. The memory control method 200 can be used for the memory control system 100 in FIG. 1. As shown in FIG. 1 and FIG. 2, the memory control method 200 can include the following steps.

Step 210: initiate the memory access instruction C to the cache controller 120 to search the cache memory 110;

Step 220: check if a cache miss occurs; if so, enter Step 230; otherwise, enter Step 235;

Step 230: check if the memory access instruction C is corresponding to predetermined conditions; if so, enter Step 240; otherwise, enter Step 245;

Step 235: access data with the cache memory 110.

Step 240: inform the replacement mask logic unit 150; enter Step 250;

Step 245: access data with the main memory 170.

Step 250: provide predetermined data D to store the predetermined data D into the cache memory 110.

In Step 210 and Step 220, the processor 105 can initiate the memory access instruction C and send the memory access instruction C to the cache controller 120 to search the cache memory 110.

In Step 230, the cache controller 120 can send the first signal S1 to the bus transaction controller 130, the bus transaction controller 130 can send the second signal S2 to the address detector 140, and the address detector 140 can check if the memory access instruction D is corresponding to the predetermined conditions.

In Step 235, a cache hit occurs, so the cache memory 110 is to be accessed.

In Step 245, since the memory access instruction D is not corresponding to predetermined conditions, the main memory 170 is to be accessed.

In Step 240 and Step 250, since the memory access instruction D is corresponding to predetermined conditions, the address detector 140 sends the third signal S3 to inform the replacement mask logic unit 150, the predetermined data D can be stored from the replacement mask logic unit 150 into the cache memory 110 through the bus transaction controller 130 and the cache controller 120, and the main memory 170 is not accessed. As a result, the accesses to the main memory 170 are reduced.

Step 240 and Step 250 can be of a bandwidth saving operation since the main memory 170 is not accessed, so data accesses and memory traffic related to the main memory 170 are saved.

The predetermined conditions mentioned in Step 230 can be described as below.

(Condition-i) The predetermined conditions can include that the bandwidth saving control register 160 is set to have a predetermined value. For example, if the bandwidth saving control register 160 is set to have a value 1, the flow can enter Step 240 and Step 250 automatically without accessing the main memory 170.

(Condition-ii) The predetermined conditions can include that the memory access instruction C is corresponding to a store operation. The memory control system 100 and the memory control method 200 can be used for store operation to write the predetermined data D into the cache memory 110.

(Condition-iii) The predetermined conditions can include that the memory access instruction C is corresponding to a store operation with an address conforming to cache line alignment.

Here, cache line alignment can refer to the process of aligning data in memory such that the starting address of the data matches the boundary of a cache line. Each cache line can have a fixed size, typically measured in bytes. For example, a cache line may have 64 bytes. When data is stored in a cache memory, it is divided into fixed-size blocks known as cache lines. The size of a cache line is determined by the architecture of the processor, commonly 32 bytes or 64 bytes. Maintaining alignment of data can improve memory access performance. The concept of cache line alignment is useful in programming, especially when dealing with large amounts of data. Misaligned data access can lead to additional memory accesses, thereby impacting program performance. To ensure efficient data access, developers can align the starting position of data structures with the boundaries of cache lines to maximize cache utilization and performance.

According to an embodiment, when a part or all of Condition-i, Condition-ii and Condition-iii are met, the flow can enter Step 240 and Step 250 to avoid the accesses to the main memory 170.

According to another embodiment, the predetermined conditions mentioned in Step 230 may be as described below.

(Condition-a) The predetermined conditions can include that the memory access instruction C is corresponding to a store operation covering at least a cache line.

(Condition-b) The predetermined conditions can include that the memory access instruction C is corresponding to a store operation in a fixed direction.

(Condition-c) The predetermined conditions can include that the memory access instruction C is corresponding to a store operation for storing null data.

(Condition-d) The predetermined conditions can include that the memory access instruction C is corresponding to a store operation, where data to be stored is allowed to be elongated without affecting other data.

According to another embodiment, when a part or all of Condition-a, Condition-b, Condition-c and Condition-d are met, the flow can enter Step 240 and Step 250 to avoid the accesses to the main memory 170.

According to another embodiment, when a part or all of Condition-i, Condition-ii, Condition-iii, Condition-a, Condition-b, Condition-c and Condition-d are met, the flow can enter Step 240 and Step 250 to avoid the accesses to the main memory 170.

Regarding Condition-a, the store operation can use a whole cache line, where a cache line may be 32 bytes or 64 bytes. For example, if a cache line has 64 bytes, the 64 bytes in the cache line can be with a number 0 to a number 63. The store operation can start storing (writing) data from the first byte (e.g. a byte with a number 0) of the cache line to ensure that all data in the cache line is newly written. For example, the newly written data can be null data.

Regarding Condition-b, if a cache line has 64 bytes, the 64 bytes in the cache line can be with a number 0 to a number 63. The data should be written sequentially instead of randomly. For example, the data should be written from the first byte (e.g. a byte with a number 0) to the last byte (e.g. a byte with a number 63) in sequence instead of randomly.

Regarding Condition-c, if the data to be stored is null data, the data from the replacement mask logic unit 150 can be retrieved without accessing the main memory 170.

Regarding Condition-d, when the data to be stored by programs is allowed to be elongated without affecting the correctness of other data, the data can be elongated to be, for example, a length of a cache line.

For example, in at least one of the following operations, Step 240 and Step 250 in FIG. 2 can be performed to reduce data accesses and memory traffic related to the main memory 170:
(Operation-1) A stack push operation generated by a compiler for a call function;
(Operation-2) A write operation for memory copy/memory set in a library; and
(Operation-3) A write operation generated by scattering/transposing an array in a vector application.

Regarding Operation-1, the compiler may operate in a background, and a stack operation may be performed. In Operation-1, data can be pushed into a stack and be taken off sequentially. If a piece of data is not retrieved, another piece of data in the stack will not be used. Hence, the data amount is in control, and Step 240 and Step 250 are allowed to be performed.

Regarding Operation-2, a memory copy operation may move data from a part of a memory to another part of the memory. A memory set operation may set a part of a memory to a predetermined value, such as 0 or 1. The write operation in Operation-2 may be used for processing a large amount of data, such as data of 1 KB, 2 KB or 10 KB. Here, 1 KB can mean 1024 bytes.

Regarding Operation-3, a write operation generated by scattering/transposing an array in a vector application may be used for processing the array for artificial intelligence (AI) or machine learning. A piece of one dimensional data may be processed to generate two-dimensional data for an array, and this sort of data processing may be related to Operation-3. When processing a set of arrays, a large amount and continuous calculations may be performed, and Step 240 and Step 250 of FIG. 2 may be performed to reduce the accesses to the main memory 170.

In each of Operation-1, Operation-2 and Operation-3, a part or all of Condition-i, Condition-ii, Condition-iii, Condition-a, Condition-b, Condition-c and Condition-d mentioned above may be met, and hence Step 240 and Step 250 of FIG. 2 may be performed to reduce the accesses to the main memory 170.

Below, two embodiments related to FIG. 1 and FIG. 2 are described. In a first embodiment, the memory access instruction C can be corresponding to a predetermined period. The bandwidth saving controller register 160 can be set to have a predetermined value (e.g. 1). Then, during a predetermined period (e.g. 10000 clock cycle time), when the processor 105 send an instruction for storing data, Step 240 and Step 250 can be performed without accessing the main memory 170, and data accesses and memory traffic related to the main memory 170 are reduced. Optionally, the decision steps (i.e. Step 220 and Step 230, and related steps) of FIG. 2 can be performed if needed. Automatically, when a jump or an interrupt of a function level occurs, the bandwidth saving controller register 160 can be reset. For example, in this embodiment, a programmer can add a specific pragma of bandwidth saving at C language level. Here, a pragma can be a compiler directive that provides information to the compiler about how the code should be treated. When the pragma is set, during a process of a compiler translating C language code into assembly language, no additional write operations should occur in a kernel loop, and the memory space in use can be automatically elongated until the memory space in use is aligned with a cache line. Below, Table-1 provides a piece of C language code and a corresponding piece of assembly language code for reference. The C language code of Table-1 can be converted to generate the assembly language code of Table-1. As a result, the accesses to the main memory 170 caused by store commands are effectively reduced, and the latencies of waiting for cache memory to transmit data are effectively reduced.

TABLE 1

| | |
|---|---|
| for (cnt = 0 ; cnt < 1000 ; cnt= cnt + 1){ | loop_kernel: |
| *(dst + cnt) = *(src + cnt); | add cnt,0x1 |
| } | add addr,offset |
| | load data,addr |
| | store data,addr |
| | beq cnt,cnt_val,loop_end |
| | jump loop_kernel |
| | loop_end: |
| | nop |
| C language code | Assembly language code |

In a second embodiment, the memory access instruction C can be corresponding to a predetermined memory range. In this embodiment, one or more control register(s) can be used to define the predetermined memory range. When a store command is used to access the predetermined memory range, Step 240 and Step 250 can be performed without accessing the main memory 170, and data accesses and memory traffic related to the main memory 170 are reduced. Optionally, the decision steps (i.e. Step 220 and Step 230, and related steps) of FIG. 2 can be performed if needed. Automatically, when a jump or an interrupt of a function level occurs, the controller register(s) can be reset.

In summary, with the memory control system 100 and the memory control method 200, data accesses and traffic to the main memory 170 are effectively reduced. The latencies of waiting for cache memory to transmit data are effectively reduced. The cost of accessing memories and memory traffic are effectively decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory control method after a cache controller processing a memory access instruction to search a cache memory and a cache miss occurs, comprising,
checking, by an address detector, if the memory access instruction corresponds to predetermined conditions;
transmitting, by the address detector, a signal to inform a replacement mask logic unit while the memory access instruction corresponds to the predetermined conditions; and
providing, by the replacement mask logic unit, predetermined data to store the predetermined data into the cache memory.

2. The memory control method of claim 1, wherein the predetermined conditions comprise that a bandwidth saving control register is set to have a predetermined value.

3. The memory control method of claim 1, wherein the predetermined conditions comprise that the memory access instruction is corresponding to a store operation.

4. The memory control method of claim 1, wherein the predetermined conditions comprise that the memory access instruction is corresponding to a store operation with an address conforming to cache line alignment.

5. The memory control method of claim 1, wherein the predetermined conditions comprise that the memory access instruction is corresponding to a store operation covering at least a cache line.

6. The memory control method of claim 1, wherein the predetermined conditions comprise that the memory access instruction is corresponding to a store operation in a fixed direction.

7. The memory control method of claim 1, wherein the predetermined conditions comprise that the memory access instruction is corresponding to a store operation for storing null data.

8. The memory control method of claim 1, wherein the predetermined conditions comprise that the memory access instruction is corresponding to a store operation, where data to be stored is allowed to be elongated without affecting other data.

9. The memory control method of claim 1, wherein the memory access instruction is corresponding to a predetermined period.

10. The memory control method of claim 1, wherein the memory access instruction is corresponding to a predetermined memory range.

11. A memory control system comprising:
a processor configured to initiate a memory access instruction;
a cache memory;
a cache controller coupled to the processor and the cache memory and configured to receive the memory access instruction to search the cache memory and transmit a first signal if the a cache miss occurs;
a bus transaction controller coupled to the cache controller and configured to receive the first signal, and transmit a second signal corresponding to the first signal;
an address detector coupled to the bus transaction controller and configured to receive the second signal, check if the memory access instruction is corresponding to predetermined conditions, and transmit a third signal if the memory access instruction is corresponding to the predetermined conditions; and
a replacement mask logic unit coupled to the address detector and the bus transaction controller and configured to receive the third signal and provide predetermined data to the bus transaction controller to store the predetermined data into the cache memory.

12. The memory control system of claim 11 further comprising:
a bandwidth saving control register coupled to the address detector;
wherein the address detector checks if the memory access instruction is corresponding to the predetermined conditions by checking if the bandwidth saving control register is set to have a predetermined value.

13. The memory control system of claim 11, wherein the predetermined conditions comprise that the memory access instruction is corresponding to a store operation.

14. The memory control system of claim 11, wherein the predetermined conditions comprise that the memory access instruction is corresponding to a store operation with an address conforming to cache line alignment.

15. The memory control system of claim 11, wherein the predetermined conditions comprise that the memory access instruction is corresponding to a store operation covering at least a cache line.

16. The memory control system of claim 11, wherein the predetermined conditions comprise that the memory access instruction is corresponding to a store operation in a fixed direction.

17. The memory control system of claim 11, wherein the predetermined conditions comprise that the memory access instruction is corresponding to a store operation for storing null data.

18. The memory control system of claim 11, wherein the predetermined conditions comprise that the memory access instruction is corresponding to a store operation, where data to be stored is allowed to be elongated without affecting other data.

19. The memory control system of claim 11, wherein the memory access instruction is corresponding to a predetermined period.

20. The memory control system of claim 11, wherein the memory access instruction is corresponding to a predetermined memory range.
